(19) United States
(12) Patent Application Publication
(10) Pub. No.: US 2009/0161105 A1
(43) Pub. Date: Jun. 25, 2009

(54) Method for Ascertaining and Monitoring Fill Level of a Medium In a Container Using the Travel-Time Method

(75) Inventor: Qi Chen, Maulburg (DE)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH + Co. KG, Maulburg (DE)

(21) Appl. No.: 11/988,279

(22) PCT Filed: May 16, 2006
(86) PCT No.: PCT/EP2006/062337

§ 371 Date: Jan. 5, 2009

(30) Foreign Application Priority Data
Jul. 5, 2005 (DE) 10 2005 031 667.0

(51) Int. Cl. G01J 4/00

(52) U.S. Cl. 356/369

(57) ABSTRACT

A method for ascertaining and monitoring the fill level of a medium in a container according to the travel-time measuring method, wherein, via a first coupling element of an antenna, high-frequency transmission signals are transmitted with a predetermined polarization plane (11) of the electric field, wherein the polarization plane of an electric field of the transmission signal is oriented essentially at a plane angle (θ) of approximately 45° to a plane (N_{L}), which contains a propagation vector (k_{S}) of the transmission signal and the surface normal of an inner wall of the container or the surface normal of a disturbance element in the container, and wherein the fill level is ascertained on the basis of the reflection signal coupled back into the first coupling element.

The invention relates to a method for ascertaining and monitoring fill level of a medium in a container using the travel-time method, wherein, via a first coupling element of an antenna, high-frequency transmission signals are transmitted with a predetermined polarization plane of the electric field, and wherein, on the basis of reflected signals coupled back into the first coupling element, the fill level is ascertained.

Such methods for ascertaining and monitoring fill level in a container are used frequently in measuring devices of automation and process control technology. The present assignee, for instance, produces and sells measuring devices under the mark Micropilot, which work according to the travel-time measuring method and serve for ascertaining and/or monitoring fill level of a medium in a container. In the case of the freely radiating travel-time measuring method, for example, microwaves, or radar waves, are transmitted via an antenna, or, in the case of use of ultrasonic waves, are transmitted via ultrasonic transducers, into a free space, or process space, and the echo waves reflected on the surface of the medium are received back, following the distance-dependent travel time of the signal, again by the antenna, or measuring transmitter. From the time difference between the transmission of the high-frequency pulses and receipt of the reflected echo signals, the distance from the measuring device to the surface of the medium can be ascertained. Taking into consideration the geometry of the interior of the container, the fill level of the medium can be ascertained as a relative, or absolute, quantity. The so-called FMCW method (Frequency Modulated Continuous Waves) can likewise be used in connection with the above measuring principle for fill level measurement and with the above methods.

A general problem in the case of all freely radiating measuring methods for ascertaining fill level according to the travel-time measuring method is the development of multi-path propagations and disturbing reflections of measuring signals on installed objects in the container, e.g. on stirrers, reinforcements and pipes and the container wall. By the multi-path propagation of transmitted and reflected signals, the reflection signals, or echoes, are slightly shifted in time, as received by the antenna, or the receiving element, as the case may be. The superimposition of the various reflected signals due to the multi-path propagations lead to a distortion of the envelope curve, or echo curve, formed from the reflection signals, and, consequently, to a deterioration of measurement accuracy. Furthermore, reflected signals of the fill level having a lesser amplitude can be completely covered by disturbance echo signals of larger amplitude, whereby ascertainment of fill level becomes difficult.

Electronic masking of multi-path reflection signals and disturbance reflection signals due to installed objects or the tank wall by means of circularly polarized microwaves is disclosed in the patent application EP 1 431 723 A1. This publication discusses, among other things, how, by means of different, circularly polarized waves, the fill level measurement signal can be made distinguishable and recognizable from the disturbance signals in the echo envelope curve. Additionally, it is possible, by decomposition of the circularly polarized signals (RHCP, LHCP) into two different, orthogonal, linearly polarized signals (YLP, XLP) and their separate evaluation, to improve the signal-to-noise ratio, i.e. it becomes possible in this way, to distinguish the direct echo signals (surface signals) from the reflected disturbance signals (interfering echoes). This decomposition of the total reflection signal into disturbance signals and echo signals is possible in this publication by a signal processing evaluation technology which is associated with a high demand on computational resources.

An object of the invention is, therefore, to provide a method for reducing disturbance reflection signals in reflected signals of freely radiating measuring devices for ascertaining fill level according to the travel-time method.

This object is achieved, according to the invention, by a method for ascertaining and monitoring fill level of a medium in a container using the travel-time method, wherein, via a first coupling element of an antenna, high-frequency transmission signals are transmitted with a predetermined polarization plane of the electric field, wherein the polarization plane of the electric field of the transmission signals is directed essentially at an angle of approximately 45° to a plane containing the propagation vector of the transmission signal and the surface normal of an inner wall of the container or the surface normal of a disturbance element in the container, so that components of reflection signals parallel to the polarization plane are coupled back into the first coupling element and the coupling of the components of reflection signals orthogonal to the polarization plane into the first coupling element is prevented, and wherein, on the basis of the reflected signals coupled back into the first coupling element, the fill level is ascertained. The advantages of this invention are that the measuring accuracy and the availability of freely radiating measuring devices for ascertaining fill level according to the travel time method are improved. Availability of a measuring device refers to the probability that the measuring device fulfills defined demands by, or within, an agreed-upon time.

In an especially preferred form of embodiment of the invention, it is provided that the orthogonal components of reflected signals are received at least via a second coupling element of the antenna orthogonal to the first coupling element.

In an advantageous form of embodiment of the solution of the invention, it is provided that the orientation of the polarization direction is checked and adjusted on the basis of a difference forming or comparison analysis of the parallel components of reflection signals with the orthogonal components of reflected signals.

A practical embodiment of the apparatus of the invention provides that the signal power of the orthogonal components of reflected signals coupled into the second coupling element is ascertained.

An advantageous embodiment of the solution of the invention provides that the position of a reflected signal of a disturbing element and/or position of a reflected signal of a multi-path echo is ascertained. An advantage of this embodiment is that, by ascertaining the position of reflection signals of a disturbance element and/or position of a reflection signal of a multi-path echo in the container, an evaluation of the reflected signals can be done at the first coupling element. Furthermore, due to knowledge of the positions of disturbing elements and the inner wall, a corresponding, optimal orientation of the antenna at the container can be made, whereby as little energy as possible of the transmission signals is radiated onto disturbing elements or the inner wall and, thus, the large part of the energy is radiated on the direct path to the surface of the medium and is reflected therefrom back into the antenna.

In an advantageous embodiment of the apparatus of the invention, it is provided that the polarization plane of the high-frequency transmission signals is oriented by a rotation of the antenna in a process connection.

An advantageous embodiment of the solution of the invention is that wherein rotation of the antenna is effected in the process connection by an automatic rotation apparatus.

An especially advantageous further development of the solution of the invention provides that the polarization plane is indicated at least by a marking element, for the purpose of orienting the antenna.

In an advantageous form of embodiment of the method of the invention, it is provided that the polarization plane of the high-frequency transmission signals is oriented via the transmitting/receiving unit by an electronic control of at least two coupling elements.

An advantage of the invention, especially as compared with the European patent (EP 1431723 A1), is that the antenna transmits linear or quasi-linear, polarized waves and the polarization plane of the waves is oriented at a certain plane angle of about θ=45° to the container wall. By this special orientation of the polarization plane of the transmission signal, the polarization plane of the reflected signals, whose propagation paths extend over multi-path propagations or by multiple reflections on the container wall or disturbing elements, reach the antenna rotated by 90°. Due to the orthogonality of the polarization plane of the reflected signals arising thereby relative to the direction of the first coupling element, the reflected signals not reflected directly from the fill level surface, but, instead, by multiple reflections on the container wall or disturbing elements and being rotated as regards polarization, are no longer received by the antenna, or its first coupling element. The distortion, or broadening, of the fill level echo signal, or the reflection signals of the fill level, in an echo curve, which is calculated from the enveloping of reflection signals, is suppressed by this method, whereby a narrower and more exact reflection signal of the fill level can be produced. A signal processing evaluation of reflected signals taking into consideration different polarizations is not absolutely necessary, since the coupling of the reflected signals produced by multi-path propagation is at least partially prevented by the construction of the antenna with the first coupling unit and the orientation of the linear polarization plane.

The invention and selected examples of embodiments will now be explained on the basis of the appended drawings. For simplification, identical parts are provided in the drawings with equal reference characters. The figures show as follows:

FIG. 1 a schematic overall presentation of a first form of embodiment of the measuring device having a rod antenna and mounted on a container;

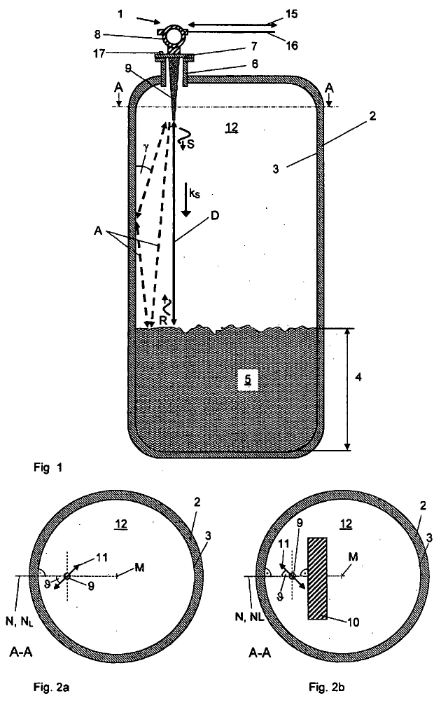

FIG. 2a a sectional view of the overall presentation of FIG. 1, as taken on the cutting plane A-A;

FIG. 2b a further sectional view of the overall presentation of FIG. 1, as taken on the cutting plane A-A;

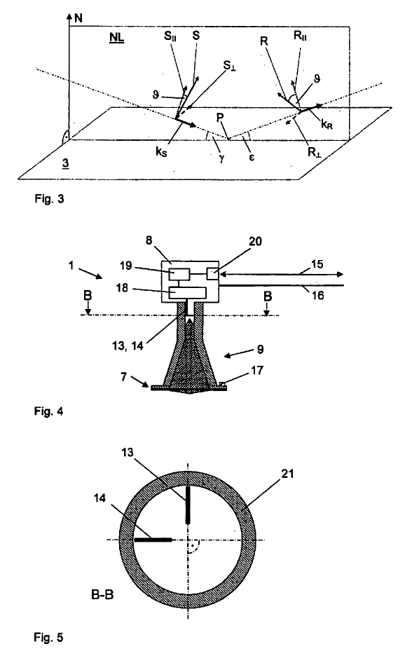

FIG. 3 a schematic representation of a reflection on the tank wall or on a disturbing element;

FIG. 4 a schematic presentation of a second form of embodiment of a measuring device with a horn antenna; and

FIG. 5 a sectional view of the schematic presentation of the second form of embodiment of FIG. 4, as taken on the cutting plane B-B.

FIG. 1 shows a measuring device 1 for ascertaining fill level 4 of a medium 5 in a container 2 using an amplitude-modulated or frequency-modulated travel-time measuring method. Measuring device 1 is secured via a flange 7 to a nozzle or process connection 6 on the container 2, so that the antenna 9, e.g. a rod antenna, is located in the process space 12 and so that the measuring transmitter 8 with transmitting/receiving unit 18, evaluation electronics 19 and fieldbus unit 20 (not otherwise shown here) are located outside of the process space 12. By means of the transmitting/receiving unit 18 in the measuring transmitter 8, a pulse-shaped transmission, or sent, signal S is produced, which is coupled via a first coupling element 13 in linearly polarized state into the antenna 9. Antenna 9 radiates the transmission signal S in the direction of the propagation vector k_{S} of the transmission signal S into the process space 12. In this case, it is attempted to excite only the fundamental mode of the transmission signal S, e.g. the HE₁₁-mode in a horn antenna and the TE₁₁-mode in the case of a rod antenna. Both have a radiation characteristic directed onto the medium 5. The radiation characteristic of the antenna 9 is most often so developed, that a radiation angle of the transmission signal S is as small as possible in the direction of the propagation vector k_{S}. By limiting the excitation to the fundamental mode of the transmission signal, it is avoided that energy fractions of the transmission signal S are radiated into side lobes or higher modes of the antenna 9.

For process plant technical reasons, it is often only possible to install the measuring device 1 on the edge of the container 2 near the inner wall 3 of the container 2. Additionally installed in container 2 are process technical devices, or installed objects, 10, such as e.g. stirring blades, cooling tubes, additional measuring devices 1, inlet and outlet tubes. These installed objects 10 and the inner wall 3 of the container 2 can lead to the fact that the transmission signal S does not travel via the direct path D from the antenna 9 to the medium 5, and back as a direct path reflection signal R_{D}, but, instead, due to the installed objects, or disturbing elements, 10, a multi path propagation A of the transmitted multi-path transmission signal S_{A} and/or the multi-path reflection signal R_{A} is developed. A superposition of the two reflection signals R_{A}, R_{D} in the antenna 9 with different travel paths and travel times effects a time shift of the measured direct path reflection signal R_{D}, or the fill level echo signal. By way of example, suppose the multi-path reflection signals R_{A} and the multi-path transmission signals S_{A} are totally reflected with a small angle of incidence γ on the inner wall 3 of the container 2. These multi-path reflection signals R_{A} superimpose in the antenna 9 on the direct path reflection signal R_{D} which leads to the fact that the reflection signals R of direct reflection signals R_{D} regularly reflected on the surface of the medium 5 are covered or broadened, this leading to a reduction of measurement accuracy of the measuring device 1 in the ascertaining of the fill level 4.

Measuring device 1 is supplied with required energy, or power, via an energy supply line 16. Measuring device 1 communicates via a fieldbus 15 with a remote switching center, or other measuring devices 1. The data transmission or communication via the fieldbus 15 is done, for example, using a CAN-, HART-, PROFIBUS DP-, PROFIBUS FMS-, PROFIBUS PA-, or FOUNDATION FIELDBUS-standard. If the measuring device 1 is embodied as a two-conductor measuring device, then the energy, or power, supply, of, for example, 48 mW, and the communication are cared for exclusively and simultaneously via a shared two-conductor line, whereby there is then no need for a separate energy supply line 16.

FIGS. 2a and 2b are examples of sectional views of the measuring device 1 on the container 2 as in FIG. 1, according to the cutting plane A-A. The linear polarization plane 11 of the transmission signal S in the antenna 9 is represented by a symbolic double-arrow. FIG. 2a shows a state in which the polarization plane 11 of the antenna 9 is oriented at a plane angle θ of about 45° relative to the surface normal plane N_{L} of the inner wall 3 of the container 2. FIG. 2b shows a state in which the polarization plane 11 of the antenna 9 is oriented relative to the surface normal plane N_{L} of the inner wall 3 of the container 2 and to the surface normal plane N_{L} of a disturbance element, or installed object, 10. In the case of different directions of the surface normals N, or the surface normal planes N_{L}, of the disturbance element 10, respectively the inner wall 3, the polarization plane 11 is oriented relative, for example, to the disturbing element 10 or the inner wall 3 of the container 2 that is positioned nearest to the antenna 9 and/or produces the greatest disturbance signal.

In the state of the art, the linear, or quasi linear, polarization plane 11 of the transmission signal S is oriented at a plane angle θ of 0° or 90° to a surface normal N or a surface normal plane N_{L} of the inner wall 3 of the container 2 or a disturbance element, this leading to the fact that the direct path reflection signal R_{D} of the fill level 4 and the multi-path reflection signal R_{A} of the multi-path propagation A are received superimposed in the antenna 9. The surface normal planes N_{L}, the linear or quasi linear polarization plane 11, as well as the inner wall 3 of the container 2 are shown only two dimensionally in FIGS. 2a and 2b, and their third dimension extends perpendicularly to the plane of the drawing. As shown in FIGS. 2a and 2b, the surface normal planes N_{L}, or surface normals N pass through the center point or the center line M of the container 2 in the case of a circular cross section of container 2.

According to the invention, the polarization plane 11 of the antenna 9 is arranged at a plane angle θ of approximately 45° relative to a surface normal N and or surface normal plane N_{L} of the inner wall 3 or installed object 10. By this embodiment, the superposition of the direct path reflection signal R_{D} from the medium 5 via the direct path propagation D by the multi-path reflection signals R_{A} of the multi-path propagation A is prevented, in that the multi-path reflection signals R_{A} can no longer be coupled back into the antenna 9 or the first coupling element 13.

FIG. 3 shows the case of multiple reflection on a section of the inner wall 3 of the container 2. The illustrated reflection of a transmission signal S at a medium boundary surface can be easily derived from the Fresnel equations, assuming a shallow angle of incidence γ of the transmission signal S with propagation vector k_{S}. This will not be carried out explicitly here. The transmission signal S of propagation vector k_{S}, in-coming with a shallow angle of incidence γ onto the boundary surface, or inner wall, 3, is reflected as reflection signal R of propagation vector k_{R} at an angle of reflection E. According to the law of reflection, the angle of incidence γ is equal to the angle of reflection 6. It is necessary, further, to consider that, in the following, only the electric field vectors of the transmission signal S and reflection signal R are considered. The polarization direction 11 of the transmission signal S, or the electric field vector of the electromagnetic wave of the transmission signal S, can be decomposed into the component S_{∥} of the transmission signal S parallel to the surface normal plane N_{L} and the component S_{⊥} of the transmission signal S perpendicular to the surface normal plane N_{L}. If the polarization plane 11 is oriented exactly at a plane angle θ of 45° to the surface normal plane N_{L}, then parallel components S_{∥} of the transmission signal S and orthogonal components S_{⊥} of the transmission signal S are equal in magnitude. The orientation of the polarization direction 11 of the transmission signal S can be ascertained by vector addition of the parallel component S_{∥} of the transmission signal S and the orthogonal component S_{⊥} of the transmission signal S, as determined relative to the surface normal plane N_{L} of the inner wall 3 or the installed objects 10.

The reflection of transmission signals S at a boundary surface or inner wall 3 in the case of a small angle of incidence γ can, as apparent from FIG. 3, be described in the following manner. The parallel components S_{∥} of the transmission signal S, whose electric field vectors lie in the surface normal plane N_{L} or are parallel thereto, are reflected back, again parallel to the surface normal plane N_{L}, as parallel components R_{∥} of the reflection signals R. The orthogonal components S_{⊥} of the transmission signal S, whose electric field vectors are oriented perpendicularly to the surface normal plane N_{L}, are reflected on the inner wall 3, or boundary layer, as orthogonal components R_{⊥} of the reflection signals R rotated by a plane angle θ of 180°, or as orthogonal components R_{⊥} phase-shifted by 180°. By the phase jump of 180° of the orthogonal components of the reflection signals R, the linear polarization plane 11 of the transmission signal S is transferred at the reflection point P into a polarization plane 11 of the reflection signals R rotated by 90°. This polarization direction 11 of the reflection signals R rotated by 90° can no longer be coupled into the antenna 9, or into the first in-coupling element 13, since its linear polarization plane 11 is directed orthogonally thereto and the reflection signal R rotated by 90° has no components in the direction of the first in-coupling element 13.

In the case of the reflection signals R reflected on the direct path D from the medium 5, the linear polarization plane 11 is rotated by 180° in comparison to the transmitted transmission signals S. By the reflection on the surface of the medium 5, only a phase shift of 180° is experienced between the transmission signals S and the reflection signals R, whereby the reflection signals R, rotated by 180°, are coupled back into the antenna 9 and into the first coupling element 13.

FIG. 4 illustrates a further example of a measuring device 1 of the invention with an antenna 9 in the form of a horn, with the horn being filled with a dielectric material. Via a first coupling element 13 and/or, in some cases, a second coupling element 14, a linearly, or quasi linearly, polarized transmission signal S produced in the transmitting/receiving unit 18 of the measuring transmitter 8, is coupled into the dielectric filling-body of the horn antenna. The transmission signal S is radiated directed toward the medium 5 in the process space 12 in a particular fundamental mode, e.g. in the H₁₁-mode, and is received back by the antenna 9 and the coupling elements 13, 14 on the direct path D or via multi-path propagations A, or multiple reflections.

In the transmitting/receiving unit 18 and evaluation unit located in the measuring transmitter 8, the reflected signals R are signal-processed and evaluated. From the reflection signals R, for example, by sequential sampling, a time-expanded, intermediate frequency signal is ascertained, from which an envelope curve of the received maximum amplitudes of the reflection signals R is calculated as a function of travel-time.

Measuring device 1 communicates with remote measuring devices 1 or with a switching central via a fieldbus unit 20 and the fieldbus 15. Mounted on flange 7 is, for example, a marking element 17, which displays the polarization plane 11 of the transmission signal S of the antenna 9 or the measuring device 1. The marking element 17 is, for example, a sticker, a notch, a weld tack, a mounted small body, or paint in the form 6f an arrow, dot or line.

FIG. 5 is a sectional view of the presentation of measuring device 1 of FIG. 4, as taken on the cutting plane B-B. In the hollow conductor 21 of the antenna 9, a first coupling element 13 and a second coupling element 14 arranged orthogonally thereto are provided. The first coupling element 13 produces the linearly polarized transmission signal S and receives the reflection signal R reflected on the direct-path D from the surface of the medium 5. The second coupling element 14 is used for receiving the reflection signal R reflected by the multi-path propagation A. The reflection signals R reflected by multi-path propagation A contain information concerning position, dimensions, and surface character of disturbance elements, or installed objects, 10 and the inner wall 3 of the container 2. From this information, the reflection signals incoming at the first coupling element 13 can be further verified, in that the signal portions of the reflection signals, which are reflected from the disturbance elements, or installed objects, 10 and the inner wall 3 of the container 2 can be brought out by calculation. For example, by a corresponding difference forming of the reflection signals R at the first coupling element 13 and at the second coupling element 14, the signal portions of the disturbing elements, or installed objects, 10 and the inner wall 3 can be separated out of the received reflection signals R of the first coupling element 13.

Since the position of the disturbing elements, or installed objects, 10 in the container 2 does not change, it is possible, for instance, to ascertain from the reflection signals R received with the second coupling element 14 the propagation velocity of the electromagnetic waves in the gas phase. This velocity ascertainment is important for an exact travel-time measurement, since the propagation velocity of the electromagnetic waves changes due to environmental conditions, such as e.g. temperature and gas mixing ratio.

By the separated detection of the direct-path reflection signals R_{D}, e.g. of the fill level 4, and the multi-path reflection signals R_{A}, e.g. of installed objects, these two reflection signals R_{D}, R_{A} can be evaluated separately from one another. In this way, appropriate knowledge from the multi-path reflection signals R_{A}, such as e.g. the positions of installed objects 10, can be taken into consideration in the direct-path reflection signals. In case signal portions of the disturbing elements 10 are nevertheless still received by the first coupling element 13, it is possible from the multi-path reflection signals R_{A} received at the second coupling element 14 to remove these by means of signal processing techniques in the evaluation unit. In conclusion, one can summarize by saying that, due to the orientation of the polarization direction 11 of the transmission signals S of the first coupling element 13 at a plane angle θ of 45° to the surface normal plane N_{L}, the direct-path reflection signals R_{D} of the surface of the medium 5 are separated from the multi-path reflection signals R_{A} of the installed objects 10 or inner wall 3.

Additionally, by the multi-path reflection signals R_{A} of the multi-path propagation A, an evaluation of the direction of the linear polarization plane 11 is possible, in that the signal powers P of the multi-path reflection signals R_{A} and the signal power of the direct-path reflection signals R_{D} are ascertained and compared with one another. From a difference forming or comparison analysis of the received direct-path reflection signals R_{D} at the first coupling element 13 with the multi-path reflection signals R_{A} of the second coupling element 14, a statement can be made concerning the orientation of the polarization plane 11 of the transmission signals S of the antenna 9 relative to the surface normal plane N_{L} of the inner wall 3 of the container 2 or of installed objects 10. The measuring device 1 is, for this purpose, switched into an orientation mode, in which, alternately, a state of the instantaneous orientation of the linear polarization plane 11 is ascertained and, accordingly, for example, the orientation of the antenna 9 in the process connection 6 is changed. The orientation of the antenna 9 can, for example, be adjusted by an automatic orienting mechanism, e.g. an electric motor driven, rotary flange.

Since most containers have a cylindrical form, one must proceed on the basis of a lightly curved surface of the inner wall 3. The spatial direction of the approximated surface normal N can be very easily ascertained by ascertaining the radius, which intersects the center point M of the container 2 and the center of the nozzle 6.

### LIST OF REFERENCE CHARACTERS

1 measuring device
2 container
3 inner wall, inner surface
4 fill level
5 medium
6 nozzle, process connection
7 flange, securement element
8 measuring transmitter
9 antenna
10 disturbing element, installed objects
11 polarization plane
12 process space
13 first coupling element
14 second coupling element
15 fieldbus
16 energy supply line
17 marking element
18 transmitting/receiving unit, producing unit
19 evaluation unit
20 fieldbus unit
21 hollow conductor
S transmission signals
S_{∥} parallel components of the transmission signals
S_{⊥} orthogonal components of the transmission signals
S_{A} multi-path transmission signals
S_{D} direct-path transmission signals
R reflection signals
R_{∥} parallel components of the reflection signals
R_{⊥} orthogonal components of the reflection signals
R_{A} multi-path reflection signals
R_{D} direct-path reflection signals
N surface normals
N_{L} surface normal plane, plane
k_{S} propagation vector of the transmission signals
k_{R} propagation vector of the reflection signals
M center point, center line
D direct-path propagation, direct-paths
A multi-path propagation, multi-paths
γ angle of incidence
∈ angle of reflection
θ plane angle, angle

1-9. (canceled)

10. A method for ascertaining and monitoring the fill level of a medium in a container according to a travel-time method, comprising the steps of:
transmitting high frequency transmission signals (S) via a first coupling element of an antenna with a predetermined polarization plane of an electric field; and
orienting the polarization plane of the electric field of the transmission signals essentially at a plane angle (θ) of approximately 45° to a plane (N_{L}), which contains a propagation vector (k_{S}) of the transmission signal (S) and a surface normal (N) of an inner wall of the container, or a surface normal (N) of a disturbance element in the container, so that components (R_{∥}) of reflection signals (R) parallel to the polarization plane are coupled back into a first coupling element and coupling of components (R_{⊥}) of reflection signals orthogonal to the polarization plane are blocked from entering into the first coupling element, wherein;
on the basis of the reflection signals (R) coupled back into the first coupling element, the fill level is ascertained.

11. The method as claimed in claim 10, wherein:
the orthogonal components (R_{⊥}) of reflection signals (R) are received via a second coupling element of the antenna orthogonal to the first coupling element.

12. The method as claimed in claim 11, further comprising the step of:
checking and adjusting the orientation of the polarization direction on the basis of a difference forming or comparison analysis of parallel components (R_{⊥}) of reflection signals (R) with orthogonal components (R_{⊥}) of reflection signals (R).

13. The method as claimed in claim 11, wherein:
signal power (P) of orthogonal components (R_{⊥}) of reflection signals (R) coupled into the second coupling element is ascertained.

14. The method as claimed in claim 11, wherein:
the position of a reflection signal of a disturbing element and/or position of a reflection signal of a multiple echo (R_{A}) is ascertained.

15. The method as claimed in claim 10, wherein:
the polarization plane of the high-frequency transmission signals (S) is oriented by a rotation of the antenna in a process connection.

16. The method as claimed in claim 15, wherein:
the rotation of the antenna in the process connection is performed by an automatic rotating apparatus.

17. The method as claimed in claim 10, wherein:
the polarization plane is given at least by a marking element for the purpose of orienting the antenna.

18. The method has claimed in claim 10, wherein:
the polarization plane of the high-frequency transmission signal (S) is oriented by an electronic control at least of two coupling elements via a transmitting/receiving unit.
